(19) United States
(12) Patent Application Publication
(10) Pub. No.: US 2021/0267405 A1
(43) Pub. Date: Sep. 2, 2021

(54) DRIP FILTER HEAD AND METHOD

(71) Applicant: Koninklijke Douwe Egberts B.V., Utrecht (NL)

(72) Inventors: Pieter Jacobus Veenendaal, Utrecht (NL); Johannes Cornelis Nieuwlaat, Utrecht (NL); Robert Stanley Farr, Hurley (GB)

(21) Appl. No.: 17/253,101

(22) PCT Filed: Jul. 8, 2019
(86) PCT No.: PCT/EP2019/068295

§ 371 Date: Dec. 16, 2020

(30) Foreign Application Priority Data
Jul. 12, 2018 (GB) 1811438.9

(51) Int. Cl. A47J 31/057; A47J 31/06; A47J 31/44; A47J 31/52

(52) U.S. Cl. CPC A47J 31/057; A47J 31/5255; A47J 31/446; A47J 31/0631

(57) ABSTRACT

This invention provides a drip filter head for a beverage apparatus comprising a connected array of beverage extraction units, each unit comprising an extraction chamber, and further comprising at least one filter.

### TECHNICAL FIELD OF THE INVENTION

The present invention relates to devices and apparatus for the extraction of coffee to produce beverages, particularly to devices and apparatus that operate under atmospheric pressure. The invention further relates to devices and apparatus that may be used in conjunction with traditional filter coffee machines.

### BACKGROUND TO THE INVENTION

‘Drip filtering’ is a known method of extracting a beverage liquid from a bed or dispersion of coffee. The known method relies on a beverage extraction device comprising a generally funnel shaped filter device, having a conical or frusto-conical chamber leading to an aperture or a tubular parallel-walled outlet. A conical or frusto-conical filter paper lines the chamber, which forms a screen between the chamber and the funnel outlet for coffee extract. To use such a device the process consists generally of loading ground coffee into the chamber, onto the filter, to form a coffee bed and then pouring water over and through the coffee bed such that coffee extract is delivered through the filter and out of the funnel outlet, leaving the coffee bed behind. In general, there is also a container below the filter, such as a cup or jug, and there may or may not be a further conduit between filter and container in order to gather and channel the extract as it comes from the filter.

Water is driven through the known drip filter beverage extraction devices under gravity. The flow rate of water through known drip filter devices is further limited and impaired by the resistance of the coffee bed and filter paper and such resistance is enhanced during use as the particulate coffee is carried onto the filter paper by the flow of water clogging the pores of the filter paper, such that water flow rate through a known drip filter is slowed dramatically as water flows through the beverage extraction device.

The coffee bed and water contact time is known to be important for extent of coffee extraction. A coffee bed and water contact time that is too long results in an over-extracted, bitter beverage. Conversely a coffee bed and water contact time that is too short results in a beverage that is less flavoursome.

Drip filter beverage extraction devices of the prior art rely on a steady and consistent addition of water to the upper chamber in order to optimise the extraction of the coffee. Machines are known that go some way to providing a solution, including “filter coffee machines”, such as the Styline® TKA8011, manufactured by Bosch, and are well known in the art. These coffee filter machines act in much the same way as manual drip filter devices with the additional advantages of controlled temperature and flow of water into the extraction device and coffee bed and, usually, a heated plate to store the container of extracted beverage underneath the extraction device.

As the flow rate through a drip filter or filter coffee machine of the prior art is determined largely by the resistance of the coffee bed and filter and it is known that this resistance increases as water flows through devices of the prior art it is also known that:
The first portion of beverage extracted through the coffee bed of devices of the prior art may be under-extracted, yielding a beverage that is weak, under developed and lacking flavour, due to a short extractable material/water contact time;
The intermediate portion of beverage extracted through the coffee bed of devices of the prior art may be optimally extracted;
The final portion of beverage extracted through the coffee bed of devices of the prior art may be over-extracted and bitter, due to a long extractable material/water contact time.

The flow rate through known drip filter devices or filter machines is significantly slowed during extraction, and therefore the coffee bed and water contact time is increased from too short (initially) to unacceptably long to produce a beverage with optimal flavour characteristics. In order to create larger volumes of coffee extract, systems ofthe prior art require the addition of larger volumes of coffee and water to the beverage extraction devices of the prior art, or repeated use of a single beverage extraction device. Each of these options present problems when attempting to produce an optimum beverage extract without expensive equipment and in a short amount of time.

When a larger volume of coffee and/or water is added to an extraction chamber of the prior art, the extraction process takes far longer to complete. This results in a large portion of the beverage extract at the end of the process being over-extracted (leading to a bitter taste) and a greater proportion of the total beverage extract having such over extracted character. Further, the length of time taken to extract the larger volume is inconvenient to the user, requiring intermediate cleaning and subsequent heating of the beverage extract. As volumes are increased the problems of over-extraction, variation in extract quality over time and long extraction times are increased.

As these volumes are increased further, the time to complete extraction is increased accordingly and the disadvantages, including the variation in the extent of extraction between the first portion of extract and the last, are amplified.

It would be advantageous to provide a beverage preparation device of the drip filter type that enables, or increases the likelihood of, the optimum or improved beverage extract flow rate and coffee and water contact time for the preparation for a well extracted beverage. Such an optimum or improved coffee and water contact time provides the conditions for a well-balanced coffee extract comprising the optimum or improved combination of levels of fast and slow extracting coffee fractions.

It would also be advantageous to provide a beverage extraction device of the drip filter type that limits the difference in extractable material/water contact time between the first and last portion of beverage extracted. Similarly, it would be advantageous to provide a beverage extraction device that limits the difference in flow rate of coffee extract from a filter during the preparation of a coffee beverage. Additionally, it would be advantageous to provide a beverage preparation device that delivers a flow of beverage extract with consistent level of extraction throughout the preparation of a beverage.

It would furthermore be advantageous to provide a beverage extraction device that allowed for flexibility in the volumes of extract that can be produced whilst providing an optimum or improved coffee and water contact time and/or reduces the difference in extent of extraction between the first and last portion of extract produced by systems of the prior art.

It would be advantageous to provide a drip filter beverage extraction device that could produce a large volume (e.g. 8 cups) of extract in the same amount of time as it takes to produce a small volume (e.g. 2 cups).

It is therefore an aim of embodiments of the invention to mitigate or reduce a disadvantage presented by the prior art.

### SUMMARY OF THE INVENTION

According to a first aspect of the invention there is provided a drip filter head for a beverage apparatus comprising a connected array of beverage extraction units, each unit comprising an extraction chamber, and further comprising at least one filter.

In some embodiments there are 2, 3, 4, 5, 6, 7, 8 or more than 8 extraction units within the drip filter head. It will be appreciated that the modular nature of the invention can be worked with almost any number of extraction units within the drip filter head, given sufficient space. Taking the space afforded by a traditional drip filter appliance and the usual number of cups required in normal use into account, it is most practical to provide a drip filter head configured to produce up to 4, 6, 8, 12, 14, 16 cups of coffee.

In some embodiments, at least a portion of each extraction unit is laterally spaced apart and extending parallel to at least a portion of the other extraction units.

In some embodiments, the extraction chambers are laterally spaced apart and extending parallel with each other.

In some embodiments, the extraction units are laterally spaced apart and extending parallel with each other.

The extraction units may be spaced apart in a planar parallel array.

Arranged in this way the drip filter head has the additional advantage of each extraction unit being able to be used to extract portions of a beverage extract in parallel, working side-by-side.

In some embodiments each extraction unit abuts at least a portion of one other extraction unit, and in embodiments where there are three or more extraction units, each extraction unit may abut at least two other extraction units

In some embodiments the drip filter head comprises tessellated array of beverage extraction units

These embodiments have the particular advantage of optimum use of space, smaller overall size and easier fit of the drip filter head into small confines of a drip filter appliance.

In some embodiments, at least one extraction chamber and/or extraction unit is removably attached to the drip filter head.

Embodiments with removable attachments of at least an extraction chamber and/or unit have the particular advantages of easy cleaning, modular emptying of spent extractable material, easy replacement or rejuvenation of filters and/or easy filling with extractable material before use. Embodiments where the extraction chamber is removably attached enables especially easy access to replace or rejuvenate the associated filter.

In some embodiments at least one filter is a separate component and may be disposable, removable, interchangeable and/or washable. Such embodiments have the additional advantage of consistent flow resistance from the filter and easy cleaning.

In some embodiments 2 or more extraction units share a single filter, in other embodiments all extraction units share a filter. In other, preferred embodiments each extraction unit comprises a distinct filter. Embodiments with shared filters have the advantage ofthe convenience of having to remove, change and/or clean just one filter or a limited number of filters while embodiments with distinct filters have the advantage of modular use and greater flexibility in extraction volume, i.e. only the filters that have been used must be removed, cleaned and/or replaced.

In some embodiments the filter is a filter paper, which may comprise, paper per se, a polymeric filter paper (such as polymeric fibres, a polymeric web or the like), or other suitable paper material.

In some embodiments, at least one of the extraction chambers has an internal diameter of between 30 mm and 100 mm, preferably between 40 mm and 80 mm, more preferably between 50 mm and 70 mm, preferably all ofthe extraction chambers have this dimension.

In some embodiments, at least one of the extraction chambers has a height, measured from the filter, of at least 50 mm, preferably between 50 mm and 200 mm, preferably all of the extraction chambers have this dimension.

In some embodiments, at least one ofthe extraction chambers has a volume ofno more than 500 ml, between 100 and 500 ml, preferably between 200-400 ml, most preferably between 250-350 ml, and preferably all of the extraction chambers have this volume.

Embodiments with any or all such dimensions have the additional advantage of providing the optimum dimensions for the preparation of 2 cups of beverage extract from each extraction unit, with the optimum or improved extractable material:water contact time during extraction.

In preferred embodiments, all of the extraction chambers have the same physical properties such as volume, height and/or the same cross-sectional area. Such embodiments have the additional advantage of similar or substantially the same extraction performance, providing even extraction between extraction chambers. In more preferred embodiments each extraction unit is substantially the same.

In some embodiments, at least two ofthe extraction units are different, preferably at least two of the extraction units have different a volume; height and/or cross-sectional area. More preferably each extraction unit comprises a different volume: height and/or cross-sectional area. More preferably, at the least two or each extraction unit comprises a different volume.

In embodiments where at least two extraction unit comprise a different volume, preferably the volume of the extraction units is scaled by a factor oftwo, in an exemplary embodiment the drip filter head comprises an extraction unit comprising a volume sufficient to produce one cup of extract; a second extraction unit comprising a volume sufficient to produce two cups of extract; a third extraction unit comprising a volume sufficient to produce four cups of coffee; and, optionally a fourth or fourth and fifth extraction units comprising volumes sufficient to produce eight and sixteen cups of coffee respectively. Embodiments with extraction units scaled in such a way provide a simplified design with fewer extraction units than embodiments of the invention with same sized extraction units, whilst maintaining the flexibility to produce a full range of cups of extract by utilising different combinations of extraction units, without overloading or adjusting the fill volume of any extraction unit.

In some embodiments, the drip filter head further comprises a water distribution device positioned to deliver water to at least two extraction units and/or chambers, preferably simultaneously or substantially simultaneously, in use. In preferred embodiments, the water distribution device is positioned to deliver water to each extraction unit and/or chamber, in use. Embodiments comprising a water distribution device have the additional advantages of: additional user convenience when adding water to multiple extraction chambers; and additional accuracy in distributing the water evenly between each extraction chamber.

In some embodiments, the water distribution device is a channel with distinct outlets for two or more extraction units and/or chambers. In preferred embodiments, there are distinct outlets for each extraction unit and/or chamber. In further embodiments, the water distribution device is at least one shower head with at least one outlet for each extraction unit and/or chamber, in preferred embodiments there is one shower head comprising outlets dispersed substantially evenly across each extraction unit and/or chamber, in other preferred embodiments there is a distinct shower head comprising multiple outlets for each extraction unit and/or chamber. Such embodiments provide a reliable method of distributing water between extraction chambers.

The water distribution device may comprise one or more valves or gating devices, which in use enable independent delivery to one, more than one, or all of the extraction units and/or chambers. For example, there may be an on-off valve or a variable water-flow valve for each unit and/or chamber, and each valve may be independently actuated. In this way, a user may easily manipulate water flow into any desired number or combination of units and/or chambers in the apparatus.

According to a second aspect of the invention there is provided the drip filter head of a first aspect of the invention wherein, at least one extraction chamber of at least one beverage extraction unit comprises an upper extraction chamber and a lower chamber separated by a filter; wherein the upper chamber comprises a perimeter wall and an inlet and the lower chamber comprises a perimeter wall and an outlet; and wherein the perimeter wall of the upper chamber adjacent to the filter tapers inwardly, towards the filter, by no more than 10 degrees and the perimeter wall of the lower chamber tapers inwardly from adjacent to or proximal to the filter. In preferred embodiments all beverage extraction units have these properties.

By “proximal” we mean generally within 8 mm of the filter, and so the tapering perimeter wall of the lower chamber may commence within 8 mm from the filter. Preferably the taper ofthe perimeter wall ofthe lower chamber commences within 7 mm, 6 mm or 5 mm, and in preferred embodiments commences within 4 mm, 3 mm, 2 mm or 1 mm, of the filter.

In some embodiments the perimeter wall of at least one upper chamber tapers by no more than 8°, 6°, 4°, 2° or no more than 1°. In preferred embodiments the perimeter wall of the at least one upper chamber is non-tapering.

In some embodiments, the perimeter wall of at least one upper chamber is parallel-sided. In preferred embodiments, the perimeter walls of each upper chamber are parallel-sided.

Parallel-sided, non-tapering perimeter walls ofthe at least one upper chamber are particularly effective because they provide an extraction chamber geometry that allows for convection of the water/coffee solution; a sufficiently high fill height for a given volume of water (vs for example the funnel shape in a drip filter appliance) to further enhance the convection; a lower deposition of coffee grounds on the sides of the container (vs for example the funnel shape in a drip filter appliance); an even deposition of coffee grounds in the coffee bed upon draining the extraction chamber, facilitating even extraction; a small footprint; a smaller liquid surface to facilitate lower heat loss.

Each upper chamber perimeter wall may be tubular and may have a circular, oval or polygonal cross-section, but is preferably circular. Embodiments in which at least one upper chamber perimeter wall has a circular cross-section and the wall is substantially entirely non-tapering are particularly useful for the achieving the benefits stated above.

In some embodiments the perimeter wall of at least one upper chamber may comprise an upper portion having an inward taper of no more than 10°, and a lower portion, adjacent to the filter, being non-tapering and parallel-sided. The upper portion may have an inward taper of no more than 8°, 6°, 4° or 2°. The upper portion may comprise no more than 50% of the total height of the perimeter wall of the extraction chamber, preferably no more than 40%, 30%, 20% or 10%. Such embodiments may have an advantage of convenient filling with an extractable beverage into the upper, tapering portion of the extraction chamber.

In some embodiments, there is a support at the bottom of at least one upper chamber for extractable beverage material. In preferred embodiments this support is a porous mesh or screen located between the upper and lower chambers.

In some embodiments this support is adjacent to the filter. The support may be above or below the filter.

In some embodiments, at least one upper chamber comprises the support or porous mesh.

The support may be fixed to the at least one upper chamber and/or lower chamber; or may be removably attached to the at least one upper and lower chamber.

In some embodiments, the support comprises the filter, while in other embodiments the beverage extraction units comprise a separate support and filter. Such embodiments have the additional advantage of allowing for extractable beverage material to be conveniently loaded into the upper chamber of the beverage extraction unit.

In some embodiments, more than 50% or 75% the filter and/or support is perpendicular to the non-tapering wall of the at least one upper and/or lower chamber, in other embodiments, substantially all of the filter and/or support is perpendicular to the non-tapering wall of the at least one upper and/or lower chamber.

Such embodiments allow for an even distribution of fluid flow through the filter and/or support and, in use, a consistent, low resistance to fluid flow from the filter and/or support.

In some embodiments, at least one upper chamber is removably attached to the corresponding lower chamber. In preferred embodiments, the at least one upper chamber is removably attached to the corresponding lower chamber such that the support (when present) and/or the filter are fixed to either the upper or lower chamber when the upper chamber and corresponding lower chamber are separated, in use.

Such embodiments have the additional advantage of convenient storage and washing of the components.

In some embodiments at least one filter is a separate component and may be disposable, removable, interchangeable and/or washable. Such embodiments have the additional advantage of consistent flow resistance from the filter and easy cleaning.

In preferred embodiments the tapering perimeter wall of at least one lower chamber is adjacent to the filter and is preferably contiguous with, adjacent to and/or abutting the filter. In such embodiments the taper of the tapering perimeter wall may commence adjacent to the filter (or support). In other embodiments there may be a short length of non-tapering perimeter wall of the at least one lower chamber, such that the tapering section ofthe perimeter wall commences no more than 8 mm below the filter (or support), preferably no more than 7 mm, 6 mm or no more than 5 mm from the filter (or support).

In some embodiments, the maximum diameter of the tapering perimeter wall or tapering section of the tapering perimeter wall of at least one lower chamber is no more than the diameter of the perimeter wall of the upper chamber adjacent to the filter. In preferred embodiments the maximum diameter ofthe tapering perimeter wall or tapering section of the at least one lower chamber is between 25% and 95% the diameter of the perimeter wall of the upper chamber, adjacent to the filter, and preferably between 35% and 90%.

In some embodiments, the tapering perimeter wall or tapering section of at least one lower chamber tapers inwardly at an angle of between 30 and 60 degrees (relative to the plane of the filter). In some embodiments, the tapering perimeter wall or tapering section of the at least one lower chamber tapers at an angle of 45 degrees relative to the plane of the filter.

Without being bound by any theory, it is believed that the use of a tapering lower chamber adjacent to or within 8 mm of the filter, has the effect of creating, in use, a meniscus of beverage extract below the filter and optimum flow resistance through the beverage extraction device for the optimum extractable material/water contact time.

In some embodiments, in use, the filter provides low resistance to the fluid flow through the beverage extraction device. Preferably, the filter provides less than 50%, 30% or 20% of the total flow resistance through at least one beverage extraction unit.

In such embodiments, in use, the flow resistance through the beverage extraction device is substantially created by the geometry ofthe extraction and lower chambers and remains consistent throughout the preparation of a beverage.

In preferred embodiments, each extraction unit is substantially the same as the others. This has the advantage of the extract from each extraction unit also being substantially the same.

According to a third aspect of the invention there is provided a method of preparing a beverage comprising, providing the drip filter head of the first or second aspect of the invention and comprising steps of:
a) Adding an extractable beverage material to at least two of the beverage extraction chambers;
b) Adding water to the beverage extraction chambers of step a); and
c) Combining and collecting the beverage extract from the beverage extraction units of steps a) and b).

In some embodiments, the water is heated water, and is preferably between 80-100° C. when it enters each extraction chamber.

In some embodiments, the volume of water added to each extraction chamber is no more than 500 ml, between 100 and 500 ml, preferably between 200-400 ml, most preferably between 250-350 ml.

Such embodiments provide the optimum conditions for the preparation of 2 cups of beverage extract per extraction chamber.

In some embodiments, the mass of the extractable beverage material is between 10 g and 50 g.

In some embodiments, the extractable beverage material is roast and ground coffee and or tea.

In some embodiments, the ratio of the volume of water added to the extraction chamber to the mass of extractable beverage material is between 10:1 and 2:1.

In some embodiments, the total extraction time initiated in step b), is less than 5 minutes, preferably less than 4 minutes, especially between 2 minutes and 5 minutes, or between 2 minutes 30 seconds to 3 minutes 30 seconds.

Such embodiments have the additional advantage of optimum extractable material/water contact time to produce an optimum or improved beverage extract and the avoidance of over-extracted extract towards the end of the preparation.

In some embodiments, the flow rate of extract from each or at least one extraction unit is between 0.8 ml/sec-2 ml/sec, most preferably between 1 ml/sec-1.6 ml/sec.

In some embodiments, the flow rate from each or at least one extraction unit over 80% of the total extraction time is substantially constant, preferably between 1 ml/sec-1.6 ml/sec.

In some embodiments, the water is added to each upper chamber at a substantially constant rate until the volume of water has been depleted.

In some embodiments, the rate of water addition to each upper chamber and the rate of beverage extract flow from each upper chamber reach a steady equilibrium state.

In some embodiments, the rate of water addition to each upper chamber is arranged to initially exceed the rate of beverage extract flow from each extraction unit, forming a filling phase.

In some embodiments, towards the end of the total extraction time, the flow of beverage extract from each unit exceeds the rate of water addition to each unit forming a draining phase.

In some embodiments, the duration of the steady equilibrium state is longer than the duration of the filling and/or the draining phase.

In some embodiments, the steady equilibrium state is between 25% and 75% of the total extraction time, preferably between 40 and 60% of the total extraction time.

In some embodiments, the duration of the steady equilibrium state is longer than the sum of the durations of the filling and draining phases and may therefore comprise greater than 50% of the total extraction time such as between 50% and 75% of the extraction time.

In such an equilibrium state the upper chamber experiences turbulence and convention flow, increasing the rate of extraction. Such embodiments have the particular advantages associated with such an equilibrium state and provide a further optimised beverage extract.

In embodiments where the total volume of water added to each extraction chamber is between 200 ml-350 ml the steady equilibrium state may be between 30 seconds and 180 seconds, preferably between 60 seconds and 140 seconds.

Such embodiments have the additional advantage of further optimised extractable material/water contact time for the preparation of 2 cups of beverage extract from each extraction unit.

In some embodiments, the water is driven through each extraction unit under atmospheric pressure, thus drainage of the drip filter head is preferably solely under the force of gravity. Such embodiments have the additional advantage of reduced complexity in manufacturing, lower cost, easier cleaning and consumer preference.

According to a fourth aspect of the invention there is provided a drip filter apparatus comprising a water heater, the drip filter head of the first or second aspect of the invention, a water distribution device for distributing heated water heated by the water heater between the extraction units and a container for gathering the output from the extraction units.

In preferred embodiments the drip filter apparatus is a drip filter appliance.

A drip filter appliance is an appliance that contains a water source and water heater configured to deliver hot water above a bed of coffee or other beverage material. The hot water mixes with the beverage material and beverage extract drips through a filter and funnel into a container, usually a heated jug. An example of a known drip filter coffee appliance is the Excellent lOSN manufactured by Douwe Egberts.

When associated with these additional components ofthe drip filter apparatus the drip filter head gains the additional advantages of user convenience and fine control of brewing parameters such as water temperature and flow rate for more consistent extraction.

### DETAILED DESCRIPTION OF THE INVENTION

In order that the invention may be more clearly understood embodiments thereof will now be described, by way of example only, with reference to the accompanying drawings, of which:

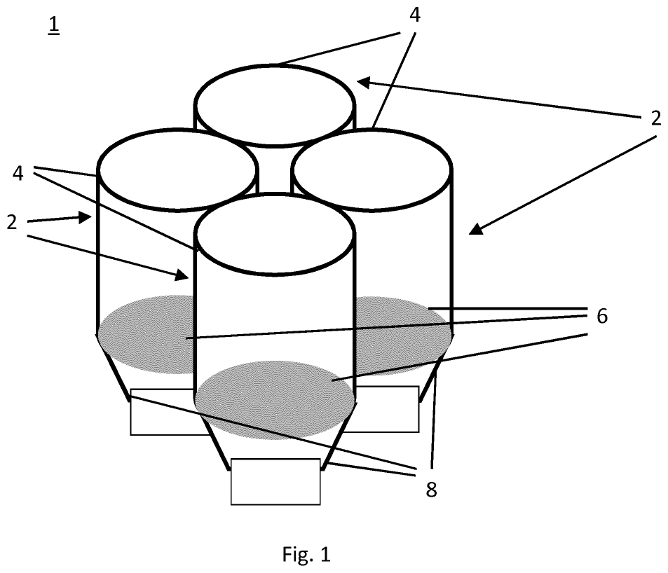

FIG. 1 is a perspective view of an embodiment of the first aspect of the invention, comprising four extraction units.

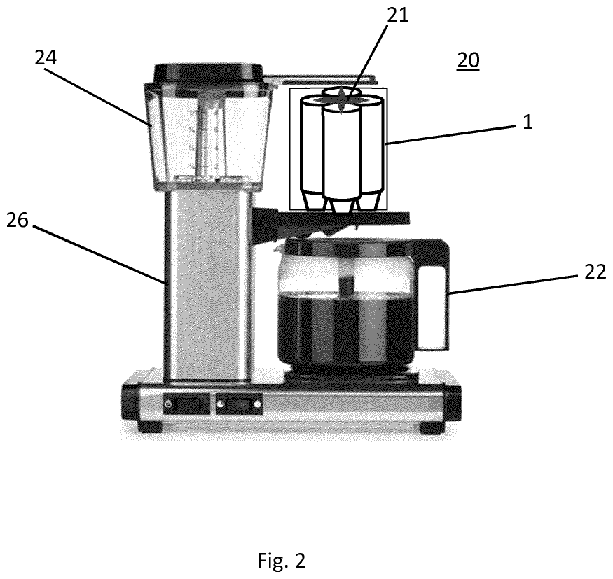

FIG. 2 is a perspective view of an embodiment of the fourth aspect of the invention comprising four extraction units.

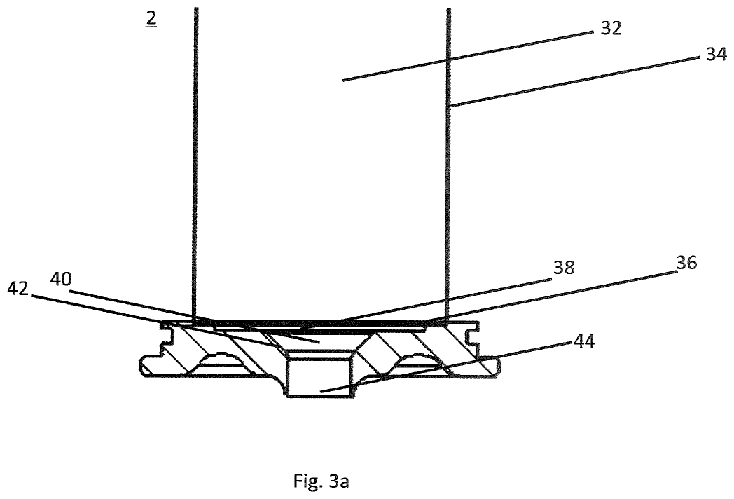

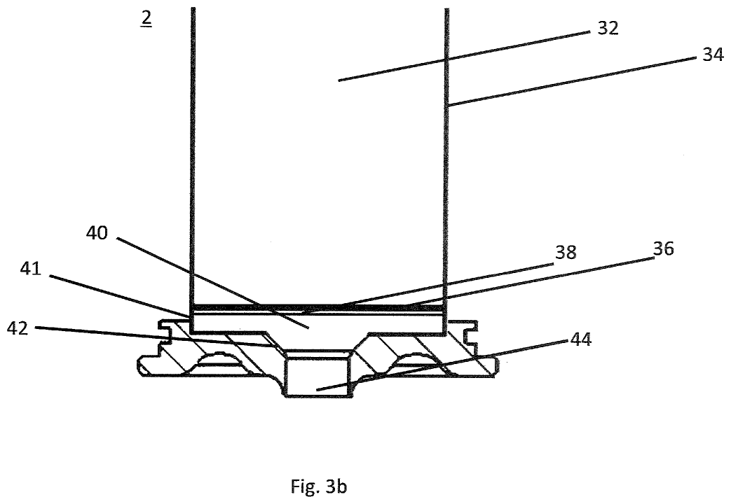

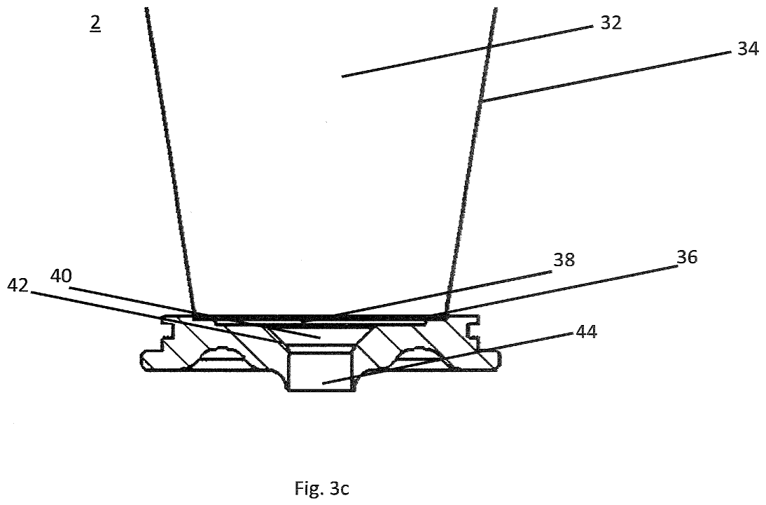

FIGS. 3a, 3b and 3c are side cross-sectional views of embodiments of a single extraction unit of the first or second aspect of the invention.

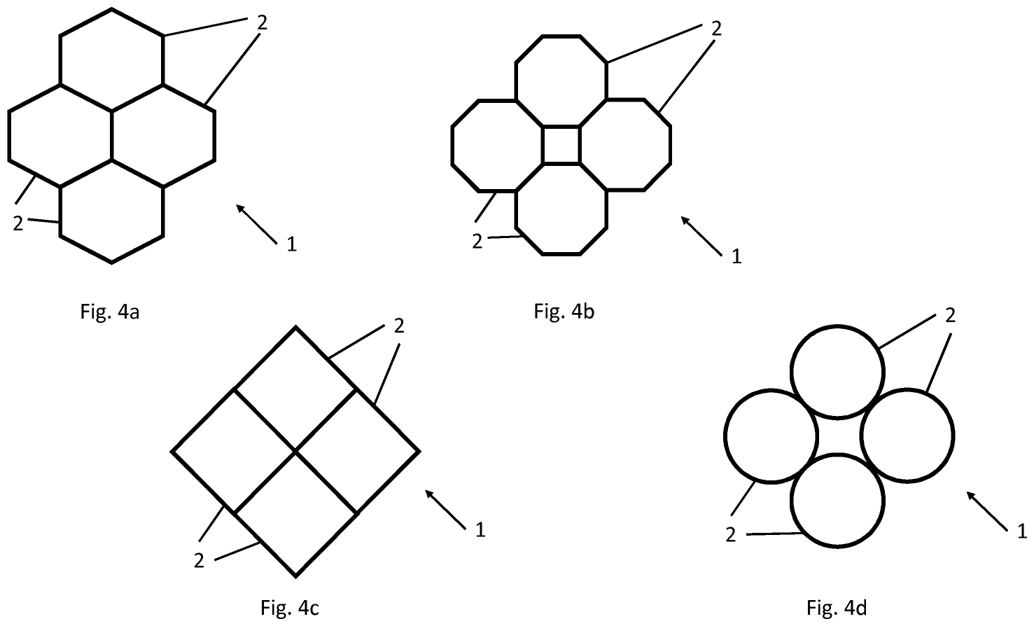

FIGS. 4a, 4b, 4c and 4d are birds-eye views of arrangements and horizontal cross-sectional shapes of embodiments of drip filter heads comprising four extraction units of the first or second aspect of the invention.

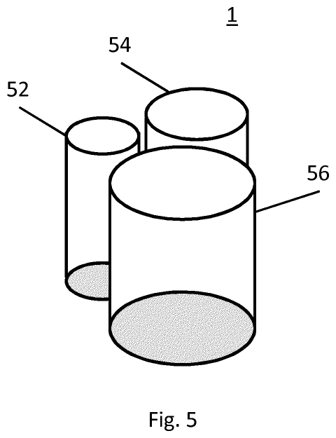

FIG. 5 is a perspective view of an embodiment of the first aspect of the invention comprising three extraction units of different sizes.

With reference to FIG. 1, a first embodiment of a drip filter head (1) of the invention, comprises an array of four extraction units (2), each comprising an upper extraction chamber (4); a filter, in the form of a filter paper (6) (fourth filter not shown); and a lower chamber which acts as an extract channelling portion, in the form of an extract funnel (8) (fourth extract funnel not shown). Each upper extraction chamber (4) has a volume of 350 ml. Each upper extraction chamber (4) is positioned above a filter (6), which, in turn, is positioned above an extract funnel (8) in order that fluid may flow from upper extraction chamber (4) to extract funnel (8) under the force of gravity, in use. Also in use, an extractable material, preferably roasted and ground coffee, and then a liquid, preferably water, are loaded into at least one and preferably two of the upper extraction chambers (4) and over time liquid extract is collected from two or more the extract funnels (8).

With reference to FIG. 2, where like numbers represent like components vis-à-vis FIG. 1, a first embodiment of a drip filter apparatus (20) ofthe invention, comprises a drip filter head (1), of the first or second aspect of the invention; a water distribution device, in the form of an water pipe with four outlets (21) a means for supplying water, in the form of a water tank (24); a drip filter apparatus body containing a water heater (26);

and a means of collecting liquid extract from the drip filter head (1), in the form of a jug (22). The water tank (24), water heater (26) and water distribution device (21) are connected together by pipework (not shown). The water distribution device (21) is located above the drip filter head (1) and configured to distribute water evenly between the extraction chambers of the drip filter head (1). The jug (22) is located below the drip filter head.

With reference to FIG. 3a, where like numbers represent like components vis-à-vis FIG. 1, a first embodiment of an extraction unit (2) of the first or second aspect of the invention comprises an upper extraction chamber (32) and a lower chamber (40) separated by a filter in the form of a porous mesh screen (36) and a paper filter (38). The upper extraction chamber (32) comprises a perimeter wall (34). The lower chamber (40) comprises a perimeter wall (42) and an outlet (44).

The upper extraction chamber perimeter wall (34) is non-tapering adjacent to the mesh screen (36). The mesh screen (36) is adjacent to and on top of the paper filter (38). In other embodiments, not shown, the vertical order of the mesh screen (36) and paper filter (38) may be reversed. The mesh screen (36) has a mesh size of 0.85 mm and thread diameter of 0.5 mm. The paper filter (38) has thickness of 1.1 mm, a low flow resistance and a diameter of less than the diameter of the upper extraction chamber (32) (approximately 80-90% of the diameter of the upper chamber (32)). The lower chamber (40) is adjacent to the paper filter (38). The perimeter wall of the lower chamber (42) tapers down away from the paper filter (38) at an angle of 45° to a minimum diameter of 15 mm over a length of 6.1 mm to meet the outlet (44). The total length from the top ofthe filter paper (38) to the end of the outlet (44) is 17 mm. The lower chamber (40) has a volume of 6 ml and the extraction chamber (32) a volume of 350 ml.

The tapering lower chamber wall (42) has a greatest diameter, adjacent to the filter (38) and mesh screen (36), of approximately 40% of the diameter of the upper extraction chamber (32).

The outlet (44) comprises a circular cross-sectional tube, having a diameter approximately 60-70% of the largest diameter of the lower chamber wall (42).

With reference to FIG. 3b, where like numbers represent like components vis-à-vis FIG. 1, a beverage extraction unit (2) comprises an upper extraction chamber (32) and a lower chamber (40) separated by a support in the form of a mesh screen (36) and a paper filter (38). The upper extraction chamber (32) comprises a perimeter wall (34). The lower chamber comprises an upper non-tapering perimeter wall section (41) adjacent to the filter (38) and mesh (36); a tapering lower perimeter wall section (42) and an outlet (44). The beverage extraction unit (2) of FIG. 3b is largely similar to the beverage extraction unit (2) of FIG. 3a; but differs by addition of the upper non-tapering perimeter wall section (41) of the lower chamber adjacent to the filter (38) and mesh screen (36) that acts to separate the tapering lower perimeter wall section (42) from the filter (38) by 5 mm; and the filter (38) extends across the full diameter of the upper extraction chamber (32) and upper extraction chamber perimeter wall (34).

With reference to FIG. 3c, in which like numbers represent like components vis-à-vis FIG. 1, a beverage extraction unit (2), comprises an upper extraction chamber (32) and a lower chamber (40) separated by a support in the form of a mesh screen (36) and a paper filter (38). The upper extraction chamber (32) comprises a perimeter wall (34). The lower chamber comprises a perimeter wall (42) and an outlet (44). The beverage extraction unit (2) of FIG. 3c is largely similar to the beverage extraction unit (2) of FIG. 1; but differs by the perimeter wall of the upper extraction chamber (34), having a taper of approximately 9° towards the filter (38).

With reference to FIGS. 4a, 4b, 4c and 4d, in which like numbers represent like components vis-à-vis FIG. 1, birds-eye views of various drip filter heads (1) of the invention are depicted comprising some suitable arrangements and shapes of extraction units (2), although other suitable arrangements and shapes exist.

With reference to FIG. 5, an embodiment of a drip filter head of the invention (1) with different sized extraction units (52, 54 and 56) is shown. The drip filter head is substantially the same as that of FIG. 1 differing in the fact that the extraction units are of different sizes. The first extraction unit (52) has a volume sufficient to produce one cup of beverage extract, the second extraction unit (54) has a volume sufficient to produce two cups of beverage extract; and the third extraction unit (56) has a volume sufficient to produce 4 cups of beverage extract. It will be understood that this sequence of extraction units could extend indefinitely in order to provide a drip filter head capable ofproducing n number of cups of extract. Drip filter heads suitable for normal consumer use may comprise extraction units comprising volumes of one, two, four and eight, or eight and sixteen cups. Variants of this embodiment may have a smallest extraction unit of two or four cups.

### EXAMPLE 1

### Preparation of a Beverage Using a Drip Filter Head of the Invention

A beverage was prepared using the drip filter head (1) of FIG. 1 by the following steps:
a) Each extraction unit (2) contained a standard coffee filter paper (6) shaped to fit flat across the full diameter of each extraction chamber (4) and the drip filter head (1) was positioned over a container;
b) 12 g of roast and ground coffee (Aroma Rood® produced by Jacobs Douwe Egberts) was loaded into each of the four extraction chambers (4) on top of the filter (6);
c) Each extraction chamber (4) was then filled with 234 ml of water heated to 80-100° C. and the beverage extract allowed to drip through the head (1) under gravity, and;
d) The beverage extract from the drip filter head (1) was collected in a single container.

The time taken from first addition of water to the drip filter head (1) until the flow of beverage extract from the drip filter head (1) had substantially stopped was 4 minutes 15 seconds. The flow of extract from the drip filter head (1) was rapid at first and slowed over the extraction time.

### EXAMPLE 2

### Preparation of a Beverage Using Enhanced Extraction Units

A beverage was prepared using the drip filter head (1) of FIG. 1 comprising the extraction units (2) of FIG. 3a by the following steps:
a) Each of the four extraction chambers (32) was loaded with 12 g of roast and ground coffee (Aroma Rood®, produced by Jacobs Douwe Egberts), each extraction unit (2) fitted with a Senseo® chocolate filter paper, code UPC05A and the drip filter head (1) supported above a beverage container;
b) 234 ml of water heated to 80-100° C. was then added at a rate of 2.6 ml/sec to each extraction chamber at a steady rate over 1 minute 30 seconds at the same time. During this time the volume of water in each extraction chamber (32) built to a maximum i.e. the flow rate of heated water into each extraction chamber (32) was the same as the flow rate of the beverage extract from each outlet (44); and
c) After the addition of water stopped, the drip filter head (1) was then left to drain until the beverage extract stopped flowing from each outlet (44). Approximately 3 minutes 15 seconds after the start of water addition to the extraction chambers.

The drip filter head (1) of FIG. 1 with the extraction units of FIG. 3a is configured such that, in use, the flow rate of beverage extract is between 1 ml/s and 1.6 ml/s throughout the extraction process. The flow rate of extract from the drip filter head (1) was slower than the flow rate of water into it.

The flow rate through each beverage extraction unit (2) is largely determined by the combination of resistances between the filter (38), mesh (36) and geometry of the lower chamber (40). The major contributors to the overall flow resistance through the head (1) of Example 1 are, without wanting to be bound by theory:
From the upper extraction chamber (32), the beverage extract undergoes a portion of horizontal flow through the filter (38) and mesh (36) in order to reach the smaller diameter lower chamber (40), maximising the resistance provided by the low resistance filter paper (38).
Upon traversing through the mesh (36) and filter paper (38) the beverage extract forms a meniscus under the mesh (36), held by surface tension and supported by the geometry of the shoulders provided by the tapering perimeter wall (or tapering section ofthe perimeter wall) of the lower chamber (36). This meniscus provides additional flow resistance below the extraction chamber.
The outlet (44) is configured (with a non-tapering perimeter wall) to provide little or no resistance to the flow of beverage extract.

There is also a contribution to overall resistance from the coffee bed and a slow increase in resistance due to the clogging of filter pores by coffee particles during extraction, but this is a far lower proportion of the total resistance through the device than in devices of the prior art, such as in Comparative Example 1, below.

By configuring the majority of the flow resistance through each beverage extraction unit (2) to be present below the coffee bed and top surface of the filter (38), each unit (2) of Example 2 benefits from a consistent flow rate throughout the extraction rather than the steadily decreasing flow rate of the prior art, such as Comparative Example 1 (below), where the flow rate through the extraction device is largely determined by the compacting coffee bed and clogging top surface of the filter. With volumes ofwater and coffee sufficient to create more than 2 beverages this effect is very significant through the extraction time.

The configuration of the upper extraction chamber (32) with a substantially parallel, non-tapering circumferential wall and the difference in flow rate into and out of each extraction unit enabled the creation of convection and turbulence in the extraction chamber of each extraction unit such that the coffee particles formed at least a partial suspension in the water during the preparation ofthe beverage—enhancing the extraction of the slow extracting coffee fractions.

Further, the geometry of the upper extraction chamber yields a sufficiently high fill height for a given volume ofwater, and so enhances convection; a lower deposition of coffee grounds on the sides ofthe container, compared to a chamber with steeply tapering sides; an even deposition of coffee grounds in the coffee bed upon draining the upper extraction chamber, facilitating even extraction; a small footprint; a smaller liquid surface to facilitate lower heat loss during the preparation of the beverage extract.

### EXAMPLE 3

### Preparation of a Beverage Using Enhanced Extraction Units within an Appliance

A beverage extract was prepared using a by loading the drip filter head (1) of FIG. 1, comprising the extraction units of FIG. 3a, into an Excellent lOSN drip filter appliance manufactured by Douwe Egberts to create the beverage preparation apparatus (20) of FIG. 2 by the following steps:
a) 12 g ofroast and ground coffee was added to each extraction chamber (32) of the drip filter head (1);
b) Cold water was added to the water reservoir (24) of the apparatus (20); and
c) The apparatus (20) was switched on to provide a steady flow of 234 ml of hot water, to each of the four extraction chambers, at a rate of 2.6 ml/sec over 1 minute 30 seconds and the beverage extract collected from the outlets (44).

The beverage extract flow rate was identical to that of Example 2 and the beverage had the same profile under sensory analysis as that of Example 2. The beverage preparation ceased after approximately 3 minutes 15 seconds from the start of water addition to the extraction chambers.

### COMPARATIVE EXAMPLE 1

### Standard Drip Filter 8 Cups

A beverage was prepared using a standard Excellent 10SN machine (Manufactured by Douwe Egberts) by the following steps:
a) A standard filter paper and 48 g of roast and ground coffee (Aroma Rood®, produced by Jacobs Douwe Egberts) were fitted to the extraction basket of the machine;
b) 1872 ml of cold water was added to the water reservoir of the machine;
c) The machine was switched on to provide a steady flow of hot water to the extraction basket until the reservoir was empty; and
d) The beverage extract was collected until the flow of extract had substantially stopped after 8 minutes 30 seconds.

### Comparison of Attributes of Beverage Produced in Each Example

A key indicator of optimum beverage extraction in a drip filter extraction method is the time that the coffee and water are in contact—coffee:water contact time. In general, if this time is too long, then the beverage extract will be over-extracted and bitter in taste; too short and the extract is under extracted and weak.

The beverage extract produced in Comparative Example 1 took over 8 minutes to produce. The first extract produced had insufficient coffee:water contact time and as a result the first extract was weak and under-extracted by the end of the extraction process, 8 minutes later, the filter paper had become clogged with coffee particles and the flow through the system was very slow. As a result, the last extract was very over extracted and bitter in flavour. This portion of slowly produced extract made up a significant portion of the total extract, this, coupled with the overall variation in quality ofthe extract throughout the process, resulted in a sub-optimal, over-extracted flavour in the whole collected beverage extract.

The beverage extract produced by Example 1 had an improved balance in extent of extraction between the first and last portion of extract that was produced. The overall extraction time was reduced from over 8 minutes to 4 minutes 15 seconds compared with Comparative Example 1, and the amount of over-extracted extract towards the end ofthe preparation time was greatly reduced.

The beverage extract produced by Example 2 provided an even further improvement over that of Comparative Example 1. The total extraction time was 3 minutes 15 seconds. This total extraction time provides the even more optimum coffee:water contact time for a particular coffee flavour preference through the extraction process. The extract produced in Example 3 showed precisely the same improvement in extract quality and attributes as Example 2 with the additional advantage of the convenience and user experience associated with the combination with a drip filter appliance.

### Further Examples of Embodiments of the Invention with Alternate Extraction Units

With reference to FIG. 3a, when in use, the beverage extraction unit (2) provides a fluid flow path for the beverage extract from upper extraction chamber (32) to lower chamber (40). All of: the route ofthe fluid flow path from extraction chamber (32) to outlet (44), the filter paper (38) and/or mesh (36) properties and the meniscus size and shape formed below the filter (38) and mesh (36) have an impact on the flow resistance and therefore coffee:water contact time and quality of the extracted beverage. The meniscus size and shape can be adjusted by variation in the maximum diameter of lower chamber perimeter wall (42). The tapering perimeter wall (42) ofthe lower chamber (40) of device (2) of FIG. 3a has the preferred maximum diameter of 40-50% the diameter of the perimeter wall of the extraction chamber (32) whereas, embodiments of an extraction unit (2) of the invention (not shown) exist that benefit from at least one of the advantages of FIG. 3a where the maximum diameter ofthe tapering perimeter wall (42) of the lower chamber of the device (2) of FIG. 3a is between one quarter to three quarters the diameter of the perimeter wall of the extraction chamber chamber(32). Further, the meniscus size and shape can be adjusted by variation in the angle ofthe taper of the perimeter wall of the lower chamber (40). In further embodiments of a beverage extraction unit (2) of the invention (not shown) the taper of the perimeter wall of the lower chamber (40) of FIGS. 3a-c may be between 35° and 55°, for example, and maintain at least one of the benefits of the invention.

FIGS. 3b and c show examples of alternative beverage extraction units (2) that may be used in conjunction with the drip filter head of FIG. 1. Each exhibits sufficient flow resistance below the coffee bed and top surface of the filter to secure the additional benefits associated with the beverage extraction unit (2) of Example 2 or 3.

Further to variations of FIG. 3a, the meniscus formation below the filter (38) and its impact on flow resistance through the extraction unit (2) can also be manipulated by spacing the tapered perimeter wall of the lower chamber (42) away from the filter (38). With reference to FIG. 3b, the short upper non-tapering perimeter wall section (41) of the lower chamber (40) provides additional volume to the lower chamber (42) without significantly hindering the formation of the coffee extract meniscus below the filter (38) and the resistance to flow through the extraction unit (2) this provides when in use. The lower non-tapering perimeter wall section (41) of the lower chamber (40) is spaced 5 mm from the filter (38).

With reference to FIG. 3c, the small taper in the perimeter wall (34) of the upper extraction chamber (32) provides an increase in volume to the extraction chamber (32) and a larger opening at the top ofthe perimeter wall (34) for ease of adding beverage material into the extraction chamber (36). No negative impact was seen, compared to the benefits associated with the device of FIG. 3a, by the inclusion of a small taper to the circumferential wall of the extraction chamber. A turbulent, convection of the coffee/water suspension was still created, there was little deposition of coffee grounds on the circumferential wall, the coffee bed was deposited evenly across the filter and the heat loss from the upper chamber was largely unaffected.

Each of the extraction units (2) of FIG. 3b or c may be used in Example 2 or 3 in place ofthe extraction unit (2) of FIG. 3a without loss or detriment to the additional benefits associated with the original Example 2 or 3.

The above embodiment is/embodiments are described by way of example only. Many variations are possible without departing from the scope of the invention as defined in the appended claims.

1. A drip filter head for a beverage apparatus comprising a connected array of beverage extraction units, each unit comprising an extraction chamber, and further comprising at least one filter.

2. The drip filter head of claim 1, wherein the drip filter head comprises between 2 and 8 extraction units.

3. The drip filter head of claim 1, wherein at least one extraction chamber has a volume of no more than 500 ml.

4. The drip filter head of claim 1, wherein the extraction chambers are laterally spaced apart and extending parallel with each other.

5. The drip filter head of claim 1, wherein the extraction units are spaced apart in a planar parallel array.

6. The drip filter head of claim 1, wherein at least one extraction chamber and/or extraction unit is removably attached to the connected array.

7. The drip filter head of claim 1, wherein each extraction unit comprises a filter.

8. The drip filter head of claim 1, wherein each extraction unit comprises the same volume, height and/or diameter.

9. The drip filter head of claim 9, wherein all extraction unit are physically substantially the same.

10. The drip filter head of claim 8, wherein the drip filter head comprises at least 4 extraction units and each extraction unit has a volume of no more than 500 ml.

11. The drip filter head of claim 1, wherein each extraction unit is different

12. The drip filter head of claim 1, wherein at least one beverage extraction chamber comprises an upper extraction chamber and a lower chamber separated by a filter; wherein the upper chamber comprises a perimeter wall and an inlet and the lower chamber comprises a perimeter wall and an outlet; and wherein the perimeter wall of the upper chamber adjacent to the filter tapers inwardly, towards the filter, by no more than 10 degrees and the perimeter wall of the lower chamber tapers inwardly from adjacent to or proximal to the filter.

13. The drip filter head of claim 12, wherein the perimeter wall of at least one upper extraction chamber is parallel-sided.

14. The drip filter head of claim 12 wherein the maximum diameter of the tapering perimeter wall of at least one lower chamber is between 25% and 95% the diameter of the perimeter wall of the upper chamber, adjacent to the filter.

15. The drip filter head of claim 1, wherein the drip filter head further comprises a water distribution device positioned to deliver water independently to the extraction units and/or extraction chambers, in use.

16. A method of preparing a beverage comprising, providing the drip filter head of claim 1, and comprising steps of:
a) adding an extractable beverage material to at least two of the beverage extraction chambers;
b) adding water to the beverage extraction chambers of step a); and
c) combining and collecting the beverage extract from the beverage extraction units of steps a) and b).

17. The method of claim 16, wherein the total extraction time of steps b) and c) is between 2 and 5 minutes.

18. The method of claims 16, wherein the flow rate of beverage extract from each extraction unit over 80% of the total extraction time is between 1 ml/sec-1.6 ml/sec.

19. A drip filter apparatus comprising a water heater; the drip filter head of claim 1; a water distribution device for distributing water heated by the water heater between the extraction units and a container for gathering the output from the extraction units.
